(19) United States
(12) Patent Application Publication
(10) Pub. No.: US 2016/0275553 A1
(43) Pub. Date: Sep. 22, 2016

(54) METHODS AND SYSTEMS FOR COMPARING MERCHANTS, AND PREDICTING THE COMPATIBILITY OF A MERCHANT WITH A POTENTIAL CUSTOMER

(71) Applicant: MASTERCARD ASIA PACIFIC PTE. LTD., SINGAPORE (SG)

(72) Inventors: Sheetanshu D. Gupta, Gurgaon (IN); Ashutosh Sharan, Gurgaon (IN)

(21) Appl. No.: 15/074,403

(22) Filed: Mar. 18, 2016

(30) Foreign Application Priority Data
Mar. 20, 2015 (SG) 10201502187R

(51) Int. Cl. G06Q 30/02

(52) U.S. Cl. CPC G06Q 30/0254; G06Q 30/0201

(57) ABSTRACT

A method performed by a computer processor is provided for predicting a subject's response to a candidate merchant. The method includes (a) receiving or generating one or more numerical similarity measures indicative of similarity between the candidate merchant and each of one or more reference merchants; (b) receiving one or more numerical transaction measures representing transactions performed by the subject with the plurality of reference merchants; and (c) obtaining a score for the candidate merchant using the respective one or more numerical similarity measures and numerical transaction measures. The score predicts the subject's response to the candidate merchant. A further compatibility score can be obtained using transaction data and data describing characteristics of the candidate merchant and the reference merchants. The two types of scores can be combined to produce an improved “total” compatibility score. A method for presenting targeted advertising material based on the scores is also provided.

### FIELD

The present disclosure generally relates to methods and systems for generating a numerical measure of the similarity of two merchants, and for predicting the compatibility of a potential customer (that is, a human subject) with one of the merchants. In particular, it provides a method and system for transmitting recommended material to subjects, such as selecting and sending targeted advertising material relating to a merchant to individual subjects who are judged to be compatible with the merchant.

### BACKGROUND

This section provides background information related to the present disclosure which is not necessarily prior art.

Targeted advertising is a type of advertising whereby advertisements or recommendations are placed so as to reach human subjects based on various traits such as demographics, psycho-graphics and behavioral variables, etc. For example, a website may offer news articles to online newspaper readers based on a prediction of a reader's interest. In another example, an online merchant may transmit advertisements or recommendations relating to products. The term “product” is used here to include any commercial product: physical objects; data products such as movies, music or computer programs; or services such as hotel or holiday bookings.

Known recommendation systems typically estimate a subject's interest in advertisements or recommendations based on his or her previous selections. For example, some online merchants offer customers suggestions of what the subjects might be interested in, or like to buy, based on the subjects' past history of purchases and/or product searches.

Two common types of interest-based recommendation systems are content-based systems and collaborative filtering systems. A content-based system examines properties of the items a user has previously selected. For instance, if a Netflix® user has watched one or more cowboy movies, then it may recommend another movie classified as having the “cowboy” feature or genre from its database to the user. A collaborative filtering system recommends items based on similarities between users and/or items. For example, items recommended to a given subject are typically ones selected by other similar individuals, who are defined as individuals who have previously selected items similar to those selected by the given subject.

It would be desirable to improve the accuracy of this process.

Furthermore, since the methods mentioned above are dependent on previous selections by a given subject, they are difficult to extrapolate to generate recommendations in relation to different sorts of items (e.g. items provided using different commercial channels to those items the subject has bought before).

### SUMMARY

This section provides a general summary of the disclosure, and is not a comprehensive disclosure of its full scope or all of its features. Aspects and embodiments of the disclosure are also set out in the accompanying claims.

The present disclosure aims to provide an effective and efficient method to obtain useful commercial information relating to (human) subjects.

In particular, the disclosure aims to provide a way of predicting the compatibility of a subject with a merchant.

This allows interested parties, such as advertising agencies and/or merchants, to identify valuable information for carrying out targeted advertising.

In general terms, the present disclosure proposes using transaction level data describing transactions subjects have had with multiple reference merchants, to identify additional merchants (“candidate merchants”) with which the subjects are likely to be compatible.

Note that the method does not require (and indeed preferably does not employ) information about what the transactions were (i.e. which products were purchased from the reference merchants in the transactions). Thus, it can be performed even in a situation in which such information is not available (e.g. a commercial secret), but in which the transaction information is available (e.g. to a financial organization which was involved in actioning the transactions).

In a first aspect, the transaction data may be used to form a numerical similarity measure indicative of a similarity between two or more merchants. In this case, subjects who, according to the transaction data, frequently interact with one or more of the reference merchants may well be compatible with similar candidate merchants.

According to the first aspect of the disclosure, there is firstly provided a method for obtaining a numerical similarity measure indicative of a similarity between a first and second merchant. The method generally comprises: (a) receiving, by a computer processor, a database containing information indicating transactions performed by each of a plurality of customers with the merchants; (b) using the database to obtain, by the computer processor, a first numerical measure representing transactions performed by each of the plurality of customers with the first merchant and a second numerical measure representing transactions performed by each of the plurality of customers with the second merchant; (c) obtaining, by the computer processor, a transaction correlation index indicating a correlation between the transactions with the first merchant and the transactions with the second merchant; and (d) obtaining, by the computer processor, the numerical similarity measure between the first and second merchant using the transaction correlation index.

This allows similar merchants to be identified by using transaction level data of customers, and is applicable irrespective of whether the merchants sell comparable products. Thus, it is applicable irrespective of whether both merchants are in the same sector or industry, etc. In other words, unlike a “one variable model”, the merchants are not compared based on their similarity in any specific characteristic (e.g. if both are in the “health and wellness” industry). Advantageously, this allows merchants with very different characteristics (e.g. in different respective industries) to be identified as capable of eliciting a similar consumer response. Thus, potentially a broader spectrum of merchants of interest can be advertised to individual target subjects accordingly.

Thus, the proposed method utilizes the “wisdom of crowd” to establish overall similarity between merchants. In particular, the transaction level data of each individual consumer with different merchants typically subsumes or captures the affinity or discrepancies between the merchants in specific characteristics or attributes (e.g. geographic location, industry, level of quality, marketing or retail channel, etc.) as perceived by the consumers. This enables merchants, which are likely to elicit a similar consumer behavior, to be identified more accurately and holistically.

Advantageously, this allows similar merchants to be identified simply using the number of transactions with the respective merchants, which is typically one dimensional data, and therefore makes the method computationally efficient.

Furthermore, the method can be performed without knowledge of what products given consumers purchased from the merchants. Such data may be proprietary and/or confidential.

Typically, the database records transactions performed by each of a plurality of customers with each of the two or more merchants.

Each of the first and second numerical measures may indicate a number of past transactions performed with the first and second merchant, respectively. In one embodiment, the first and second numerical measures indicate the number of past transactions performed during a predefined period.

In one embodiment, the first and second numerical measures are vectors in a space having respective dimensions associated with the customers, and the transaction correlation index is indicative of a difference in orientation of the vectors. The transaction correlation index may be obtained based on a cosine of the angle between the two vectors.

Optionally, step (d) includes obtaining the numerical similarity measure using a further characteristic of the first and second merchant.

The further characteristic may be geographic locations of the first and second merchant. For example, if the first and second merchant are located in the same country, state, city or regions and/or if the first and second merchant are in proximity (e.g. within a pre-defined distance to each other).

The further characteristic may be a retail channel of the first and second merchant, for example, by E-commerce such as online shopping or by retail outlets such as department store shopping, etc.

The further characteristic may also be the target market, e.g., the groups of customers targeted by the first and second merchants, respectively.

The further characteristic may also be a characteristic of the goods and/or services rendered by the first and second merchant, for example, the scope and quality of the goods or services.

Using the further characteristic of the merchants allows merchants to be identified on the basis of their affinity or similarity in a specific aspect, if necessary.

According to this first aspect of the disclosure, there is further provided a method for obtaining data for predicting a subject's response to a candidate merchant. The method generally comprises: (a) receiving, by a computer processor, one or more numerical similarity measures indicative of similarity between the candidate merchant and each of one or more reference merchants; (b) receiving, by the computer processor, one or more numerical transaction measures representing transactions performed by the subject with the plurality of reference merchants; and (c) obtaining, by the computer processor, a score for a subject using the respective one or more numerical similarity measures and numerical transaction measures; said score being predicative of the subject's response to said candidate merchant.

This enables each individual consumer's response to a specific merchant (i.e. the candidate merchant) to be predicted using his or her own past transactions data with other merchants which are perceived as similar to the candidate merchant. Therefore, this allows interested parties to select and present recommendation or advertising material according to the predicted response of the individual consumers. Note that the method can be used even if the subject (cardholder) has never interacted with the candidate merchant, or not for a very long time, such as a year.

Step (a) may comprise obtaining the numerical similarity measure between the candidate merchant and each of the one or more reference merchants by a method as described above.

The method may further comprise determining if the score meets a criterion, and transmitting data relating to the candidate merchant to the subject if the determination is positive. This helps interested parties to determine whether it is worthwhile presenting advertising material of certain merchants to the user, for example, if the costs of advertising justify the benefit of potential responses from the consumer.

In one embodiment, step (c) comprises obtaining a sum of the one or more numerical transaction measures weighted by the one or more numerical similarity measures for the corresponding reference merchant.

Typically, each of the one or more numerical transaction measures is indicative of a number of past transactions performed by the subject with the corresponding merchant, and typically during a predefined period.

Optionally, step (c) includes obtaining the score using the one or more reference merchants which have the numerical similarity measures of a pre-defined range. For example, only reference merchants with a high degree of similarity to the candidate merchant are chosen and used to predict a consumer's to the candidate merchant.

The number of the one or more reference merchants may be at least 5, at least 15 or at least 30. In one embodiment, the number of the one or more reference merchants is 50.

In a second aspect of the disclosure, which may be combined with the first aspect, the compatibility of a candidate merchant with a subject can be predicted using data describing whether the candidate merchant exhibits certain characteristics, and data describing if the reference merchants exhibit those characteristics. Thus, if the transaction data indicates that the user has previously interacted with merchants who exhibit certain characteristics exhibited also by the candidate merchant, this information can be used to produce a second score indicating the compatibility of the subject and the candidate merchant.

Unlike the first aspect of the disclosure, the second aspect requires more than transaction information about the reference merchants (and the candidate merchant), but this information may be publicly available, such as data indicating the products the reference merchant sells, their locations, etc.

According to a further aspect, there is provided a computer system having a processor and a data storage device, the data storage device storing instructions operative by the processor to cause the processor to perform a method of the above.

The disclosure may further be expressed as a computer program product. For example, a non-transitory program stored on a tangible recording medium, operative when performed by a processor to cause the processor to perform the method.

According to a further aspect, there is provided a method for transmitting targeted advertising material to one or more subjects. The method generally comprises: (a) receiving, by a computer processor, a database containing scores predicative of one or more subjects' compatibility with one or more candidate merchants; (b) selecting, by the computer processor, for the one or more subjects, customized advertising material based on the scores; and (c) presenting the one or more subjects with the respective customized advertising material.

Further areas of applicability will become apparent from the description provided herein. The description and specific examples and embodiments in this summary are intended for purposes of illustration only and are not intended to limit the scope of the present disclosure. In addition, the above and other features will be better understood with reference to the followings Figures which are provided to assist in an understanding of the present teaching.

### DRAWINGS

The drawings described herein are for illustrative purposes only of selected embodiments and not all possible implementations, and are not intended to limit the scope of the present disclosure.

With that said, embodiments of the present disclosure will now be described for the sake of example only, with reference to the following drawings in which:

FIG. 1 is a flow diagram of a method according to an embodiment of the disclosure;

FIG. 2 is an example of a database used in the first embodiment of the disclosure;

FIG. 3 is an example of a first and second numerical measure and a transaction correlation index;

FIG. 4 is a flow diagram of another method according to an embodiment of the disclosure;

FIG. 5 illustrates four of the top ranked similar merchants for a reference merchant “Harrods®”, generated by an exemplary method of the disclosure;

FIG. 6 is a list of other top ranked similar merchants for the reference merchant “Harrods®”, generated by an exemplary method of the disclosure;

FIGS. 7A, 7B and 7C show transaction data for three users for each of three restaurant characteristics; and

FIGS. 8A, 8B and 8C show data characterizing three restaurants.

Corresponding reference numerals generally indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

1. General Similarity Measure and General Compatibility Score

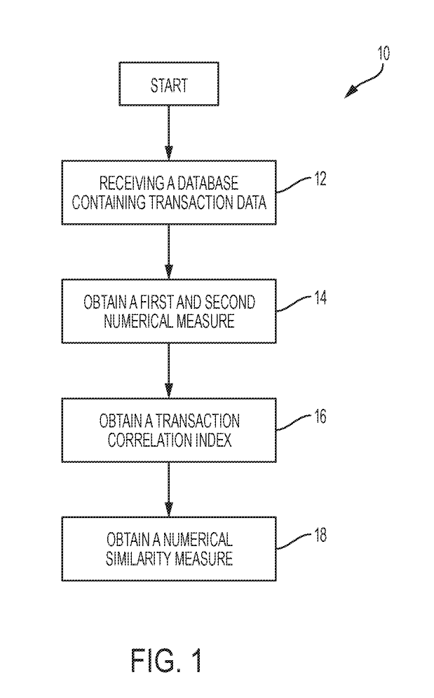

FIG. 1 illustrates an exemplary method 10 carried out by a computer processor for obtaining a numerical similarity measure indicative of a similarity between two merchants. This similarity measure can optionally be obtained without any information about the characteristics of the merchants (e.g. which products they sell), and can be obtained even if the merchants have quite different characteristics. It is hence referred to as “general”.

At step 12, the computer processor is configured to receive a database 20 (see FIG. 2) containing information associated with transactions performed by each of a plurality of customers Alice, Gary, Adam, Sam and Dean, with the merchants A-E (referred to in FIG. 2 as “Merch A” to “Merch E”).

At step 14, a first numerical measure M_{A} is obtained from the database 20. M_{A} represents transactions performed by each of the customers Alice, Gary, Adam, Sam and Dean with a merchant A. Similarly, a second numerical measure M_{B} representing transactions performed by each of the customers with a merchant B (“Merch B”) is obtained from the database 20. In this example, the numerical measures M_{A}, M_{B} are in a form of vectors in a space. Each of the dimensions of the space is associated with a respective one of the customers, and each of the components of M_{A}, M_{B} is the number of past transactions performed with the respective reference merchant by each of the customers. In other words, M_{A}, which is a vector of (5, 3, 4, 3, 1), represents that the number of transactions performed by each of the customers Alice, Gary, Adam, Sam and Dean with merchant A is 5, 3, 4, 3, 1, respectively, during a pre-defined period, for example, within a month.

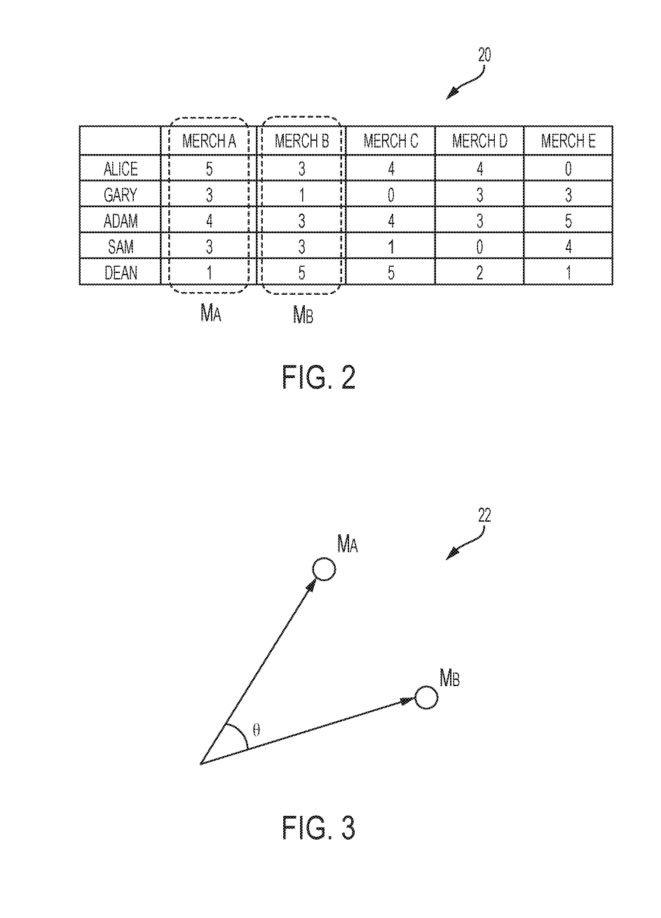

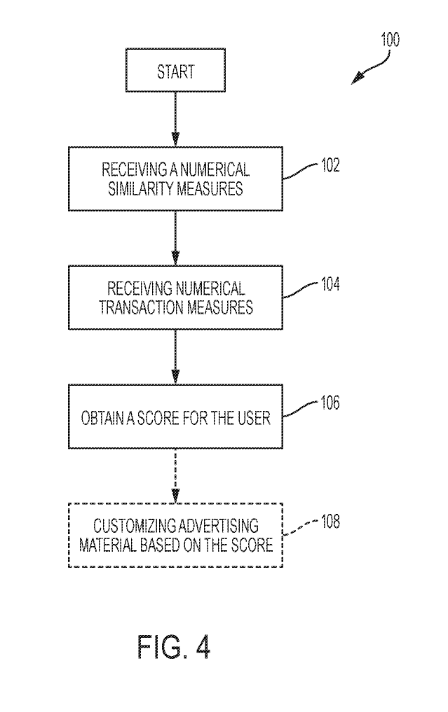

At step 16, a transaction correlation index 22 is obtained (see FIG. 3), which indicates a correlation between the numerical measures M_{A}, M_{B}, and more specifically, a difference in orientation of the vectors M_{A}, M_{B}. In one example, the transaction correlation index 22, r(M_{A}, M_{B}), between merchant A and merchant B is calculated as:

$$r ( {M}_{A} , {M}_{B} ) = cos θ = \frac{{M}_{A} \cdot {M}_{B}}{‖ {M}_{A} ‖ ‖ {M}_{B} ‖} = \frac{{\sum }_{i = 1}^{n} {M}_{Ai} \times {M}_{Bi}}{\sqrt{{\sum }_{i = 1}^{n} {( {M}_{Ai} )}^{2}} \times \sqrt{{\sum }_{i = 1}^{n} {( {M}_{Bi} )}^{2}}} \qquad ( 1 )$$

in which the i denotes each individual user while n denotes the number of users. The above is also known as the cosine similarity (a cosine of the angle) between the two vectors M_{A}, M_{B}. Other ways of calculating the transaction correlation index 22 may also be used, such as Euclidean distance, M Mahalanobis distance, or a correlation coefficient such as the Pearson correlation coefficient or Kendall's tau.

The method 10 further comprises a step 18 of obtaining the numerical similarity measure Sim(M_{A}, M_{B}) between the two merchants, merchant A and merchant B, using the transaction correlation index 22. In some embodiments, the numerical similarity measure Sim(M_{A}, M_{B}) is the same as the transaction correlation index 22.

In other embodiments, the numerical similarity measure is calculated further using one or more further characteristics of the merchants. For example, the numerical similarity measure also takes into account the affinity or discrepancies between the merchants in specific characteristics of the merchant such as the geographic proximity of the merchant.

In one example, the numerical similarity measure takes into account a perceived level of quality of the two merchants by the public. For example, if both merchants receives the same or similar Yelp™ scores, this will contribute to the numerical similarity measure to reflect a higher degree of similarity between the two merchants.

Other examples of further characteristics of the merchants are the scope of goods provided or services rendered, the marketing or retail channel, and/or embellishment of the merchant (e.g. if there is an outdoor dining area for restaurants).

The further characteristics may also include the target market of the merchants and/or level of popularity among specific groups of consumers, such as the number of visitors or customers during a predefined period.

In an exemplary embodiment, the method 10 is performed to identify a plurality of merchants with a numerical similarity measure of a pre-defined range indicating a certain level (e.g. a high level) of similarity to a candidate merchant.

FIG. 3 is another exemplary method 100 carried out by a computer processor for obtaining data for predicting a subject's response to the candidate merchant.

At step 102, a computer processor receives one or more numerical similarity measures Sim(M_{C}, M_{R}) indicative of similarity between the candidate merchant M_{C} (e.g. merchant A of FIG. 2) and each of one or more other merchants, referred to as reference merchants M_{R} (merchants B to E of FIG. 2). The similarity measure Sim(M_{C}, M_{R}) can be obtained by the method 10 for each of the reference merchants.

At step 104, the computer processor further receives one or more numerical transaction measures representing transactions performed by the subject with the plurality of reference merchants M_{R}. In one embodiment, the numerical transaction measure of method 100 is indicative of a number of past transactions performed by the subject with the corresponding reference merchants (e.g., merchants B to E).

At step 106, a score is obtained for a given user u (i.e. a human subject) using the respective one or more numerical similarity measures and numerical transaction measures. The score indicates the compatibility of the user u and the candidate merchant, and is predicative of the user u's response to the candidate merchant. In one embodiment, the score for the user u is obtained by:

$$Score ( User - u ) = \frac{{\sum }_{j = 1}^{N} Sim ( {M}_{A} , {M}_{j} ) \times T \times {n}_{uj}}{{\sum }_{j = 1}^{N} \vert Sim ( {M}_{A} , {M}_{j} ) \vert} \qquad ( 2 )$$

in which Sim(M_{A}, Mⱼ) represents the numerical similarity measure between the candidate merchant (merchant A in this case), and reference merchant j. N denotes the number of the reference merchants 1, 2, . . . N. Txnᵤⱼ denotes the numerical transaction measure performed by user u with the respective reference merchant j. In this example, the Txnᵤⱼ is the number of transactions and score is calculated as a sum of the one or more numerical transaction measures Txnᵤⱼ weighted by the one or more numerical similarity measure Sim(M_{A}, Mⱼ) for the corresponding reference merchant j.

In an exemplary embodiment, the score is obtained based on the reference merchants having the numerical similarity measures of a pre-defined range, which indicates a similarity between the Merch A and each of the reference merchants above a level. This allows the merchants having higher level of similarity with the Merch A to be used in computing the score. For example, the score for Merch A is computed based on the top 50 similar merchants to Merch A.

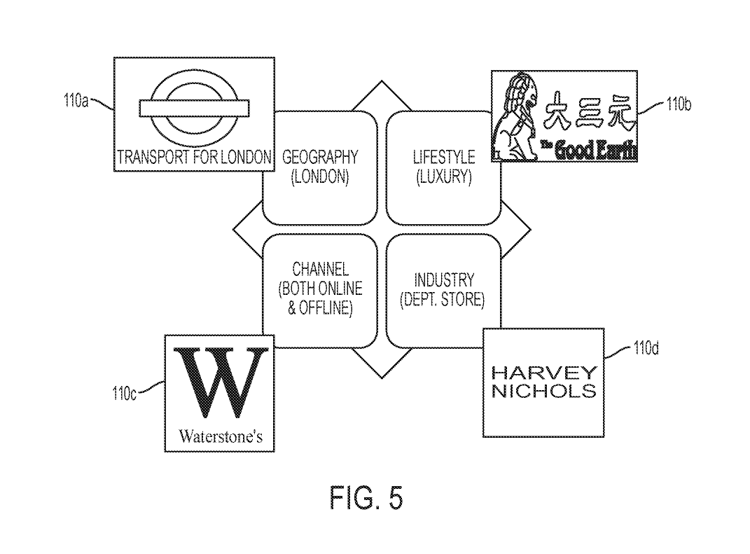

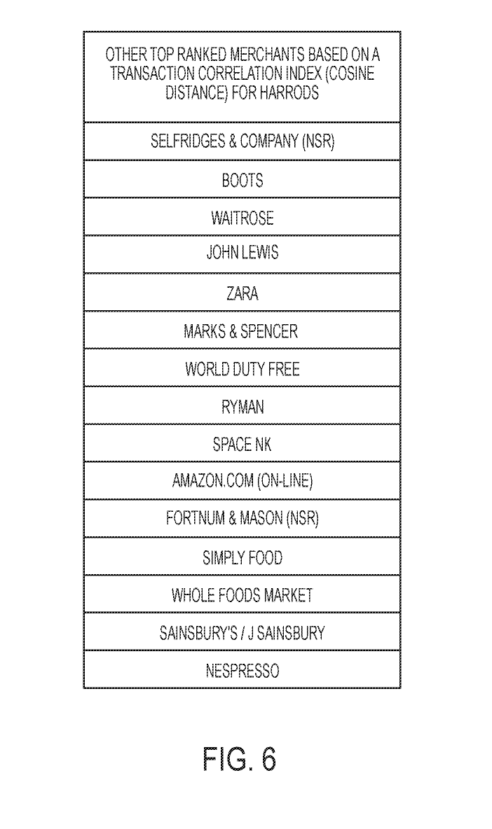

FIGS. 5 and 6 illustrate some of the top ranked similar merchants generated for the merchant “Harrods®” by the method 100.

As shown in FIG. 5, four top ranked similar merchants “Transport for London” 110a, “Good Earth” 110b, “Waterstone's” 110c, “HARVEY NICHOLS” 110d are generated with respect to a candidate merchant “Harrods”. Each of the four merchants and “Harrods” in fact has certain attributes in common. For example, “Transport for London” and “Harrods” have affinity in geographic locations (i.e. London), “Good Earth” and “Harrods” both offers luxury goods in lifestyle merchandise, “Waterstone's” and “Harrods” are similar in the channels (both online and offline) of retail, and “HARVEY NICHOLS” and “Harrods” are the same industry (both are department stores). FIGS. 5-6 demonstrate that the transaction level data of each individual consumer with different merchants is indeed capable of capturing the affinity or discrepancies between the merchants with regard to certain characteristics or attributes. Accordingly, this enables the similarity between merchants to be accurately identified using such transaction level data.

The method 100 may further have an optional step 108 of customizing advertising material to the user based on the score. This may include selecting and transmitting data relating to the candidate merchant to the user if the score is determined to meet a certain criterion, for example, if the score is above a pre-defined threshold.

The method 100 may further be used for transmitting targeted advertising material to one or more subjects, which includes a step of receiving a database containing scores predicative of one or more subjects' responses to one or more candidate merchants obtained by method 100. Based on the scores, customized advertising material can be selected for and presented to each of the one or more subjects.

2. Content-based Compatibility Score

We now turn to an embodiment of the disclosure which employs both transaction data and first content data characterizing a candidate merchant and second content data characterizing a plurality of reference merchants. The data characterizing the reference merchants could, for example, be obtained from a public source, such as Yelp, Yellow Pages, Yahoo Weather Data, Yahoo Stocks, Apple Health Apps, Zomato, etc.

The embodiment is explained using a specific example of a certain type of merchant (restaurants) but can be straightforwardly extended to other types of merchants.

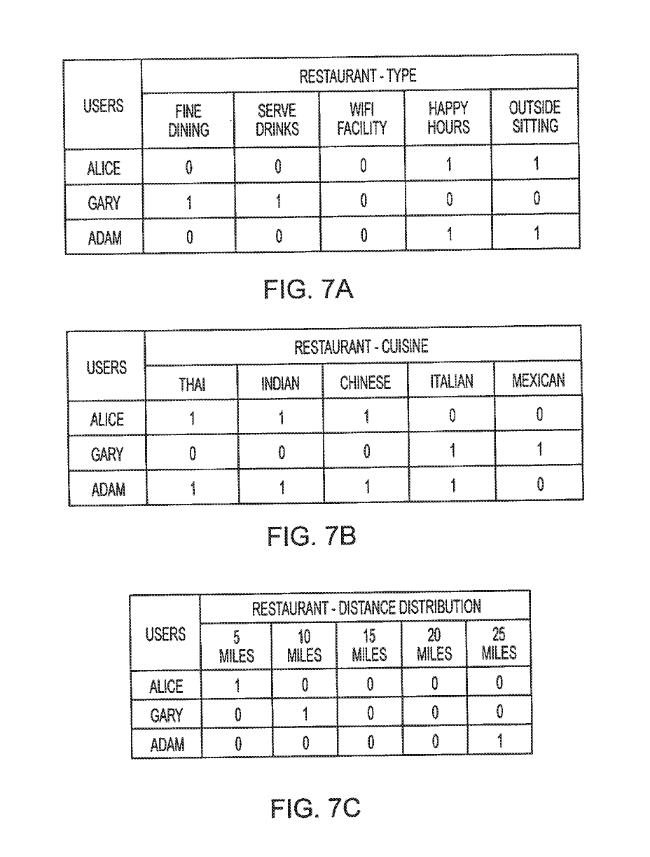

Suppose that for each of three users “Alice”, “Gary” and “Adam”, we have transaction data showing how many transactions they have had with a set of restaurants (reference merchants). For each of the restaurants for which a transaction exists, the embodiment employs second content data which indicates whether each of the restaurants exhibits a plurality of characteristics. There are three categories of characteristics: characteristics relating to the type of restaurant (whether it is fine dining, serves drinks, has a WiFi facility, has a happy hour, and has outside seating); characteristics relating to the type of food (e.g. Thai, Indian, Chinese, Italian or Mexican); and the distance of the restaurant from the corresponding user's home (0-5 miles, more than 5 but 10 miles, more than 10 but under 15 miles, more than 15 but under 20 miles, and more than 20 but under 25 miles). Thus, the system is able to compile a chart as shown in FIGS. 7A-7C showing for each of the users, the number of transactions the user has had during a given period with restaurants having each of the characteristics. The data for the first category of characteristics is shown in FIG. 7A, for the second category of characteristics in FIG. 7B, and for the third type of characteristics in FIG. 7C.

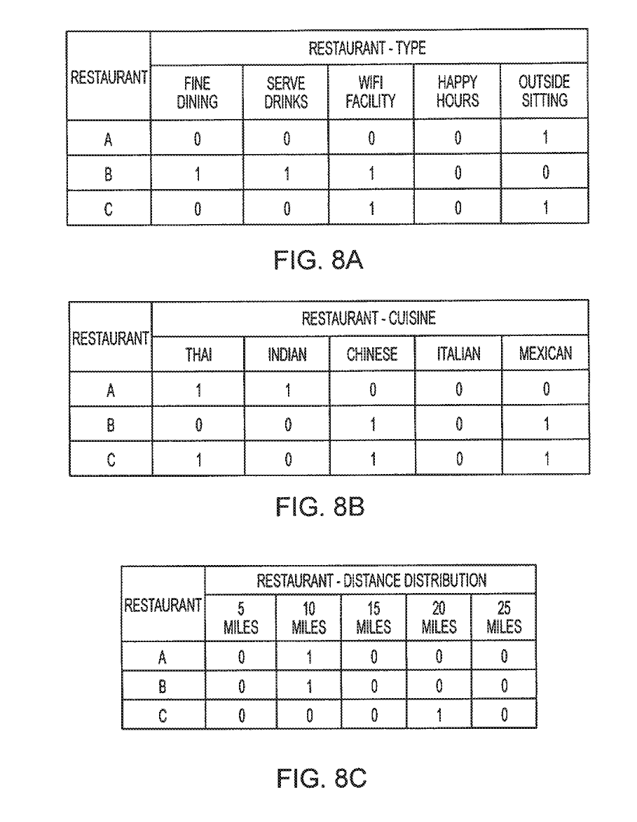

FIGS. 8A, 8B and 8C show, for each of candidate merchants (restaurants A, B and C), first content data indicating whether the candidate merchants exhibit each of the characteristics. FIG. 8A and FIG. 8B show those of the characteristics for the properties which are independent of the users: the same characteristics treated in FIGS. 7A and 7B respectively. FIG. 8C shows the distances of the three restaurants from the home of a given user Alice. Note that for the other users, Gary and Adam, FIG. 8C would be different if they live in a different place from Alice.

Using the values in FIGS. 7A-8C, the embodiment forms a “content based” measure of the compatibility of Alice with any of restaurants A, B and C. For example, the compatibility of Alice and restaurant A is

$$Compatibility ( Alice , A ) = \frac{Dot - Product ( Alice , A )}{‖ Alice ‖ \times ‖ A ‖} = \frac{\begin{matrix}0 \times 0 + 0 \times 0 + 0 \times 0 + 1 \times 0 + 1 \times 1 + 1 \times 1 + 1 \times 1 + 1 \times 0 + \\ 0 \times 0 + 0 \times 0 + 1 \times 0 + 0 \times 1 + 0 \times 0 + 0 \times 0 + 0 \times 0\end{matrix}}{Sqrt ( 6 ) \times Sqrt ( 4 )} = \frac{3}{Sqrt ( 6 ) \times Sqrt ( 4 )} = 0.612 \qquad ( 3 )$$

As in the method 100, the content-based score produced by Eqn. (3) may be used for transmitting targeted advertising material to one or more subjects. The method includes a step of receiving a database containing the content-based scores. Based on the scores, customized advertising material can be selected for and presented to each of the one or more subjects.

3. Combined Compatibility Score

A further embodiment of the disclosure obtains a “total” compatibility score indicating the compatibility of a candidate merchant with a given user, which is a function of (i) a content based score (such as that given by Eqn. (3)) and (ii) a general compatibility score (such as that given by Eqn. (2)). For example, a total compatibility score can be produced as:

$$Total Score ( Alice , A ) = \frac{\begin{matrix}A ( Content - Based Compatibility Score ) + \\ B ( General Compatibility Score )\end{matrix}}{A + B} \qquad ( 4 )$$

where A and B are coefficients, which may, for example, be chosen based on any one of more of the geography, the industry of merchant A, transaction volume, and quality of the content data.

As in the method 100, the total score produced by Eqn. (4) may be used for transmitting targeted advertising material to one or more subjects. The method includes a step of receiving a database containing the total scores. Based on the total scores, customized advertising material can be selected for and presented to each of the one or more subjects.

### Variants of the Embodiment

Many variations of the embodiment can be made within the scope and spirit of the present disclosure. For example, the numerical measures representing customer's prior transactions performed with merchants can incorporate further data describing the transactions, such as the value of transactions and/or the numbers of transactions during each of multiple respective periods of time. Similarly, the numerical measures may take a form other than a vector.

Furthermore, the mathematical expressions for calculating the transaction correlation index and the score may be formulated differently from those used in the embodiments.

The functions and/or steps and/or operations included herein, in some embodiments, may be described in computer executable instructions stored on a computer readable media (e.g., in a physical, tangible memory, etc.), and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

Further, it should be appreciated that one or more aspects of the present disclosure transform a general-purpose computing device into a special-purpose computing device when configured to perform the functions, methods, and/or processes described herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for obtaining a numerical similarity measure indicative of a similarity between a first and second merchant, the method comprising:
(a) receiving, by a computer processor, a database containing information associated with transactions performed by each of a plurality of customers with the merchants;
(b) using the database to obtain, by the computer processor, a first numerical measure representing transactions performed by each of the plurality of customers with the first merchant and a second numerical measure representing transactions performed by each of the plurality of customers with the second merchant;
(c) obtaining, by the computer processor, a transaction correlation index indicating a correlation between the first and second numerical measure; and
(d) obtaining the numerical similarity measure between the first and second merchant using the transaction correlation index.

2. The method according to claim 1, wherein each of the first and second numerical measures indicates a number of past transactions performed with the first and second merchant, respectively.

3. The method according to claim 1, wherein the first and second numerical measures are represented as vectors in a space having respective dimensions associated with the customers, and the transaction correlation index is indicative of a difference in orientation of the vectors.

4. The method according to claim 3 further including obtaining the transaction correlation index based on a cosine of the angle between the two vectors.

5. The method according to claim 1, wherein step (d) includes obtaining the numerical similarity measure using at least one further characteristic of the first and second merchant.

6. The method according to claim 5, wherein the further characteristic comprises a geographic location of the first and second merchant.

7. The method according to claim 5, wherein the further characteristic comprises a retail channel of the first and second merchant.

8. The method according to claim 5, wherein the further characteristic comprises an industry of the first and second merchants.

9. A method for obtaining data for predicting a subject's response to a candidate merchant, the method comprising:
(a) receiving, by a computer processor, one or more numerical similarity measures indicative of a similarity between the candidate merchant and each of one or more reference merchants;
(b) receiving, by the computer processor, one or more numerical transaction measures representing transactions performed by the subject with the plurality of reference merchants; and
(c) obtaining, by the computer processor, a score for the subject using the respective one or more numerical similarity measures and numerical transaction measures, said score being predicative of the subject's response to said candidate merchant.

10. The method according to claim 9, wherein step (a) comprises obtaining the numerical similarity measure between the candidate merchant and each of the one or more reference merchants, and wherein obtaining the numerical similarity measure includes:
receiving, by a computer processor, a database containing information associated with transactions performed by each of a plurality of customers with the merchants;
using the database to obtain, by the computer processor, a first numerical measure representing transactions performed by each of the plurality of customers with the first merchant and a second numerical measure representing transactions performed by each of the plurality of customers with the second merchant;
obtaining, by the computer processor, a transaction correlation index indicating a correlation between the first and second numerical measure; and
obtaining the numerical similarity measure between the first and second merchant using the transaction correlation index.

11. The method according to claim 9 further comprising determining if the score meets a criterion, and transmitting data relating to the candidate merchant to the subject if the determination is positive.

12. The method according to claim 9, wherein step (c) comprises obtaining a sum of the one or more numerical transaction measures weighted by the one or more numerical similarity measures for the corresponding reference merchant.

13. The method according to claim 9, wherein each of the one or more numerical transaction measures is indicative of a number of past transactions performed by the subject with the corresponding merchant.

14. The method according to claim 9, wherein step (c) includes identifying at least one of said reference merchants for which the corresponding numerical similarity measure is within a pre-defined range, and obtaining the score using data relating to the identified reference merchants.

15. The method according to claim 9, wherein the number of the one or more reference merchants is at least 5.

16. (canceled)

17. The method according to claim 9, wherein the number of the one or more reference merchants is at least 30.

18. A method for obtaining data for predicting a subject's response to a candidate merchant, the method comprising:
(a) receiving, by a computer processor,
(i) first content data describing whether the candidate merchant exhibits each of a plurality of characteristics;
(ii) second content data describing whether each of a plurality of reference merchants exhibits each of the characteristics; and
(iii) transaction data defining describing the number of transactions a subject has carried out with each of the merchants; and
(b) obtaining, by the computer processor, a score for the candidate merchant which is a sum over each characteristic which the candidate merchant exhibits, of a value representing the number of transactions the subject has carried out with reference merchants which also exhibit the characteristic.

19-21. (canceled)

22. The method of claim 9, wherein the score is a first score; and further comprising:
receiving, by a computer processor, first content data describing whether the candidate merchant exhibits each of a plurality of characteristics, second content data describing whether each of a plurality of reference merchants exhibits each of the characteristics, and transaction data defining describing the number of transactions a subject has carried out with each of the merchants;
obtaining, by the computer processor, a second score for the candidate merchant which is a sum over each characteristic which the candidate merchant exhibits, of a value representing the number of transactions the subject has carried out with reference merchants which also exhibit the characteristic; and
generating a third score for the candidate merchant based on the first and second scores.

23. The method of claim 9, further comprising:
selecting, by the computer processor, for the candidate merchant, one or more corresponding subjects for which the corresponding score indicates a high compatibility; and
presenting, by the computer processor, for the candidate merchant, the one or more corresponding selected subjects with advertising material relating to the candidate merchant.

24. The method of claim 18, further comprising:
selecting, by the computer processor, for the candidate merchant, one or more corresponding subjects for which the corresponding score indicates a high compatibility; and
presenting, by the computer processor, for the candidate merchant, the one or more corresponding selected subjects with advertising material relating to the candidate merchant.
